(19) United States
(12) Patent Application Publication
(10) Pub. No.: US 2017/0225965 A1
(43) Pub. Date: Aug. 10, 2017

(54) Multilayer composite materials nano-scale filter

(71) Applicants: Yong Shang Tseng, Hsinchu City (TW); Shu Yun Yu, Hsinchu City (TW); Yen Je Tseng, Hsinchu City (TW); Wen Chi Tseng, Hsinchu City (TW); Wen Jin Tseng, Hsinchu City (TW); Hong Kuan Tseng, Hsinchu City (TW)

(72) Inventors: Yong Shang Tseng, Hsinchu City (TW); Shu Yun Yu, Hsinchu City (TW); Yen Je Tseng, Hsinchu City (TW); Wen Chi Tseng, Hsinchu City (TW); Wen Jin Tseng, Hsinchu City (TW); Hong Kuan Tseng, Hsinchu City (TW)

(21) Appl. No.: 15/494,542

(22) Filed: Apr. 24, 2017

(30) Foreign Application Priority Data
Apr. 21, 2017 (TW) 106205584

(51) Int. Cl. C02F 1/00; B01D 39/14; B01D 39/16; B01D 29/01; B01D 39/10

(52) U.S. Cl. CPC C02F 1/001; B01D 29/016; B01D 39/10; B01D 39/1692; B01D 39/14; B01D 2239/1291; B01D 2239/1216

(57) ABSTRACT

A multilayer composite materials nano-scale filter apparatus includes a vessel including an inlet and an outlet; a main line for flowing contaminants to the vessel through the inlet; a filtration assembly disposed in the vessel for separating particulates from the contaminants to obtain filtered liquids, the filtration assembly including a first magnetic layer, a second magnetic layer, an intermediate filtration layer disposed between the first magnetic layer and the second magnetic layer; and an outlet line for flowing the filtered liquids out of the vessel through the outlet. The intermediate filtration layer is a steel layer or a resin layer.

### BACKGROUND OF THE INVENTION

1. Field of the Invention

The invention relates to nano-scale filters and more particularly to a multilayer composite materials nano-scale filter (MCMNF) having improved characteristics.

2. Description of Related Art

A conventional water filtering device comprises a first layer of carboxylated activated carbon impregnated with silver; and a second layer of at least one of activated alumina, activated alumina impregnated with ferric oxide and ferric oxide. The layers are arranged such that water passing through the filter passes through the first and second layer.

While the device enjoys its success in the market, continuing improvements in the exploitation of nano-filter are constantly being sought.

### SUMMARY OF THE INVENTION

It is therefore one object of the invention to provide a multilayer composite materials nano-scale filter apparatus comprising a vessel including an inlet and an outlet; a main line for flowing contaminants to the vessel through the inlet; a filtration assembly disposed in the vessel for separating particulates from the contaminants to obtain filtered liquids, the filtration assembly including a first magnetic layer, a second magnetic layer, an intermediate filtration layer disposed between the first magnetic layer and the second magnetic layer; and an outlet line for flowing the filtered liquids out of the vessel through the outlet.

The above and other objects, features and advantages of the invention will become apparent from the following detailed description taken with the accompanying drawings.

### BRIEF DESCRIPTION OF THE DRAWINGS

FIG. 1 schematically depicts a multilayer composite materials nano-scale filter according to a first preferred embodiment of the invention;

FIG. 2 schematically depicts a multilayer composite materials nano-scale filter according to a second preferred embodiment of the invention;

FIG. 3A is a longitudinal sectional view of a first configuration of the filtration assembly;

FIG. 3B is a longitudinal sectional view of a second configuration of the filtration assembly;

FIG. 4A is a perspective view of the first magnetic layer;

FIG. 4B is a perspective view of the second magnetic layer;

FIG. 5A is a perspective view of the steel layer; and

FIG. 5B is a perspective view of the resin layer.

### DETAILED DESCRIPTION OF THE INVENTION

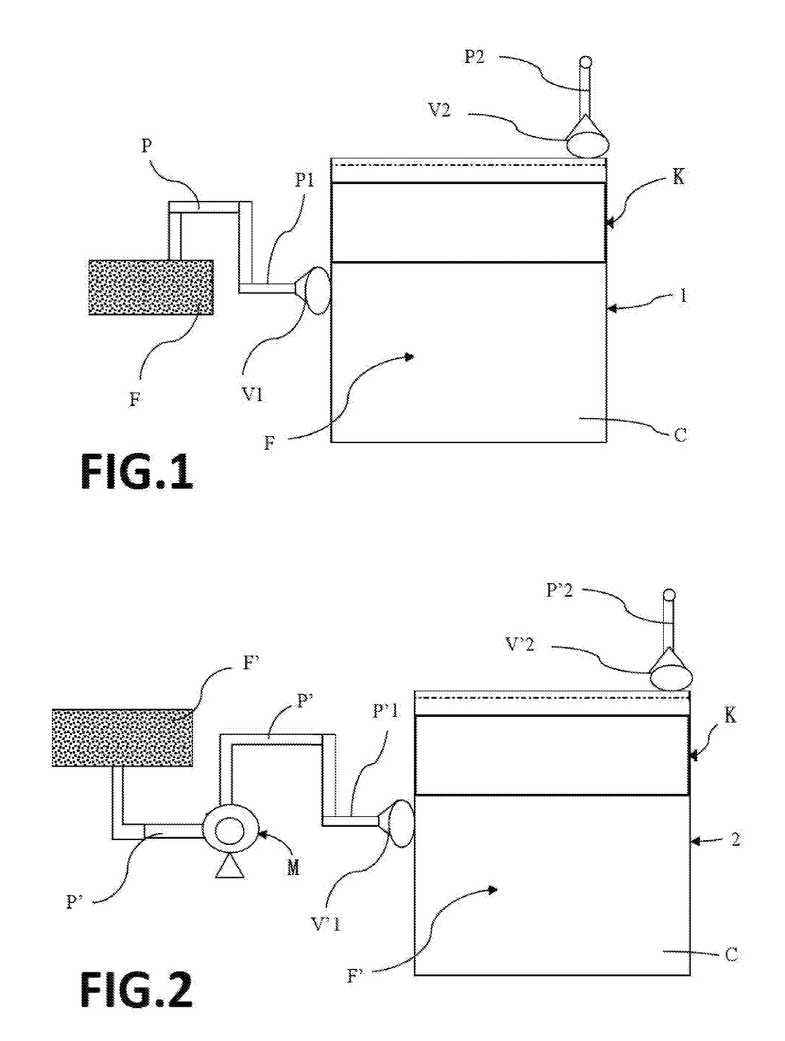

Referring to FIG. 1, a multilayer composite materials nano-scale filter (MCMNF) 1 in accordance with a first preferred embodiment of the invention comprises contaminants F, an inlet V1, a vessel C, a main line P and an inlet line P1 together for flowing contaminants from the contaminants F to the vessel C through the inlet V1, a filtration assembly K disposed in the vessel C for separating particulates from the contaminants F, an outlet V2, and an outlet line P2 for flowing the filtered liquids out of the vessel C through the outlet V2.

Referring to FIG. 2, an MCMNF 2 in accordance with a second preferred embodiment of the invention is shown. The MCMNF 2 comprises contaminants F′, an inlet V′1, a vessel C′, a main line P′, a pump M disposed in the main line P′, an inlet line P′1 together with the main line P′ for flowing pressurized contaminants from the contaminants F′ to the vessel C′ through the inlet V′1, a filtration assembly K disposed in the vessel C′ for separating particulates from the contaminants F′, an outlet V′2, and an outlet line P′2 for flowing the filtered liquids out of the vessel C′ through the outlet V′2.

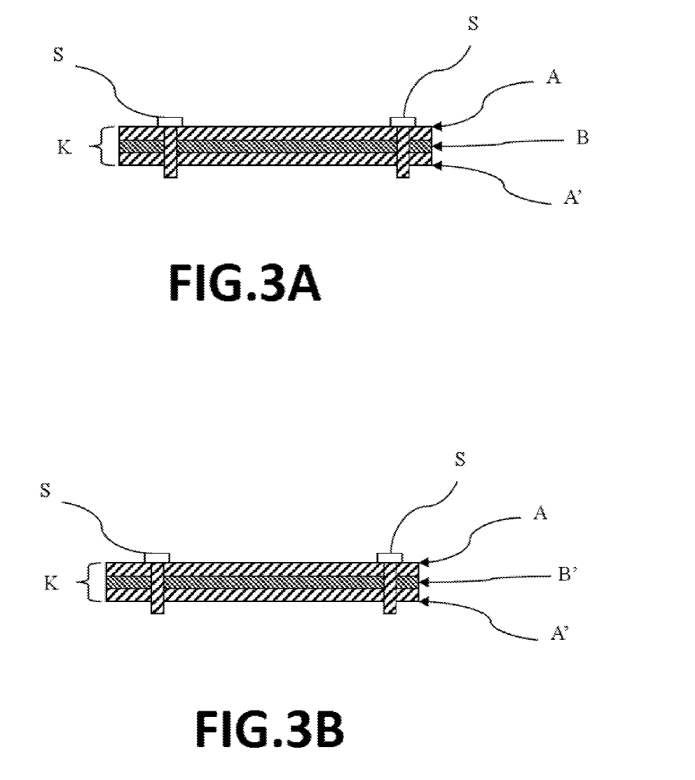

Referring to FIG. 3A, a first configuration of the filtration assembly K is shown. The filtration assembly K includes a first magnetic layer A, a second magnetic layer A′, a steel layer B disposed between the first magnetic layer A and the second magnetic layer A′, and two screws S for fastening the steel layer B, the first magnetic layer A, and the second magnetic layer A′ together.

Referring to FIG. 3B, a second configuration of the filtration assembly K is shown. The filtration assembly K includes a first magnetic layer A, a second magnetic layer A′, a resin layer B′ disposed between the first magnetic layer A and the second magnetic layer A′, and two screws S for fastening the resin layer B′, the first magnetic layer A, and the second magnetic layer A′ together.

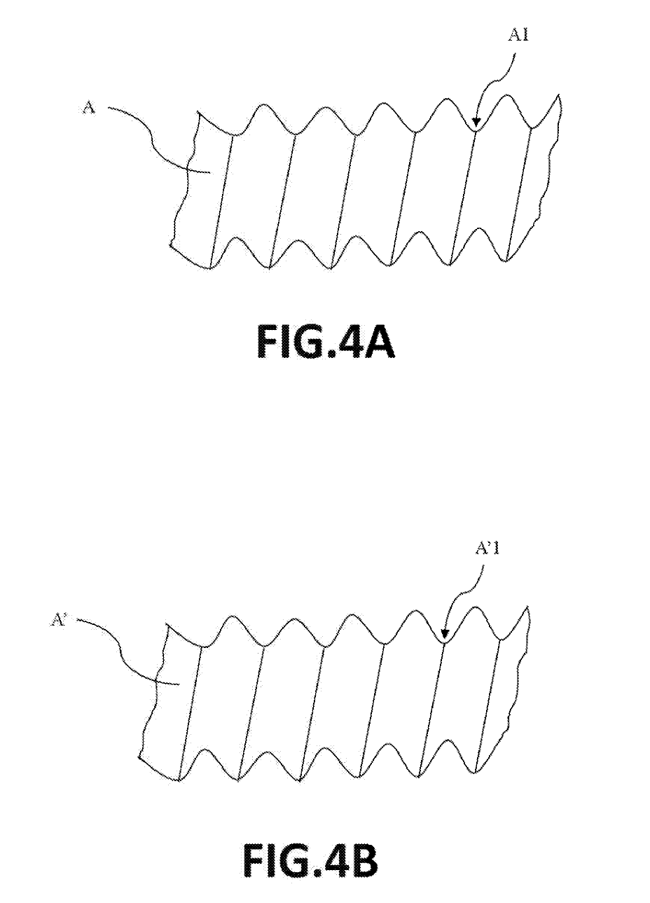

Referring to FIG. 4A, the first magnetic layer A includes a plurality of grooves Al each having a size in the range of 0.0001 to 1,000 μm.

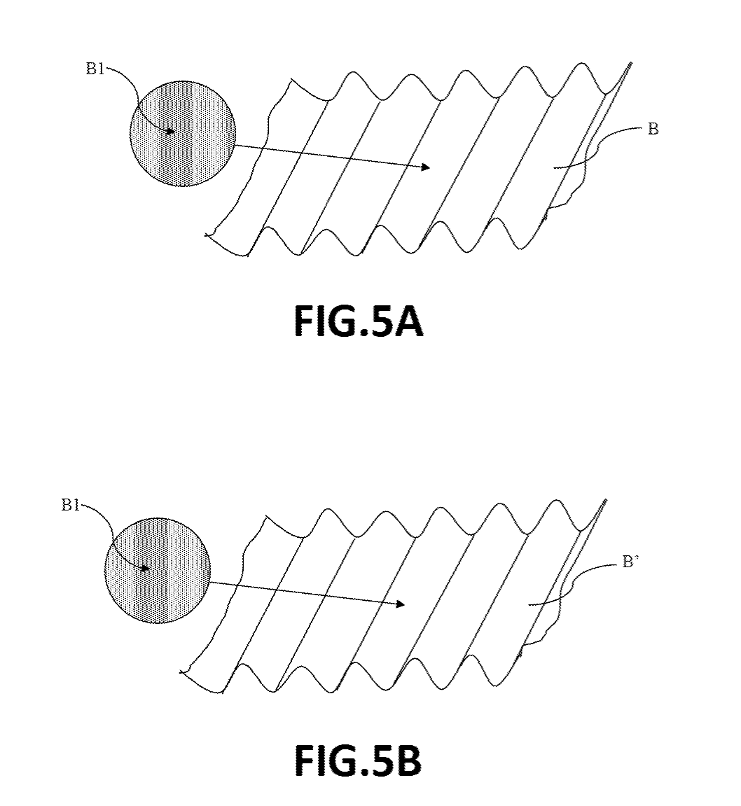

Referring to FIG. 4B the second magnetic layer A′ includes a plurality of grooves Al each having a size in the range of 0.0001 to 1,000 μm. Referring to FIG. 5A, the steel layer B includes a plurality of apertures B1 each having a size in the range of 0.0001 to 1,000 μm.

Referring to FIG. 5B, the resin layer B′ includes a plurality of apertures BI each having a size in the range of 0.0001 to 1,000 μm.

While the invention has been described in terms of preferred embodiments, those skilled in the art will recognize that the invention can be practiced with modifications within the spirit and scope of the appended claims.

What is claimed is:

1. A multilayer composite materials nano-scale filter apparatus, comprising:
a vessel including an inlet and an outlet;
a main line for flowing contaminants to the vessel through the inlet;
a filtration assembly disposed in the vessel for separating particulates from the contaminants to obtain filtered liquids, the filtration assembly including a first magnetic layer, a second magnetic layer, an intermediate filtration layer disposed between the first magnetic layer and the second magnetic layer; and
an outlet line for flowing the filtered liquids out of the vessel through the outlet.

2. The multilayer composite materials nano-scale filter apparatus of claim 1, wherein the intermediate filtration layer is a steel layer.

3. The multilayer composite materials nano-scale filter apparatus of claim 1, wherein the intermediate filtration layer is a resin layer.

4. The multilayer composite materials nano-scale filter apparatus of claim 1, wherein the first magnetic layer includes a plurality of grooves each having a size in the range of 0.0001 to 1,000 μm.

5. The multilayer composite materials nano-scale filter apparatus of claim 1, wherein the second magnetic layer includes a plurality of grooves each having a size in the range of 0.0001 to 1,000 μm.

6. The multilayer composite materials nano-scale filter apparatus of claim 2, wherein the steel layer includes a plurality of apertures each having a size in the range of 0.0001 to 1,000 μm.

7. The multilayer composite materials nano-scale filter apparatus of claim 3, wherein the resin layer includes a plurality of apertures each having a size in the range of 0.0001 to 1,000 μm.

8. The multilayer composite materials nano-scale filter apparatus of claim 1, further comprising a pump disposed in the main line.
